(19) United States
(12) Patent Application Publication
(10) Pub. No.: US 2010/0328940 A1
(43) Pub. Date: Dec. 30, 2010

(54) LENS, LED MODULE AND ILLUMINATION APPARATUS UTILIZING THE SAME

(75) Inventors: XING-GUI HUANG, Shenzhen City (CN); HAI-WEI ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/553,079

(22) Filed: Sep. 2, 2009

(30) Foreign Application Priority Data
Jun. 30, 2009 (CN) 200910303898.9

(51) Int. Cl. F21V 1/00; F21V 5/00

(52) U.S. Cl. 362/235; 362/326; 362/311.02

(57) ABSTRACT

An LED module includes an LED and a lens combined with the LED. The lens includes a light input face for light from the LED entering into the lens and a light output face refracting the light from the light input face. The light output face includes a first light output face continuously distributed thereon and a plurality of second light output faces inwardly recessed from the first light output face. The second light output faces can deflect the light extending therethrough toward a predefined area where the light extending through the first light output face is focused. An illumination apparatus utilizing the LED module is also provided.

### BACKGROUND

1. Technical Field

The present disclosure relates generally to lighting systems and, more particularly, to an illumination apparatus utilizing light emitting diodes (LEDs) as light sources.

2. Description of Related Art

LED as a new type of light source can generate brighter light, and have many advantages, e.g., energy saving, environment friendly and longer life-span, compared to conventional light sources. Therefore, the LED has a trend of substituting for conventional light source.

Nowadays one disadvantage of an illumination apparatus applying LEDs is the low utilization efficiency of light sources, in which a mount of light from the lamp always projects/illuminates an area should not be illuminated. Thus, a great deal electric energy is consumed unnecessarily.

What is needed, therefore, is an illumination apparatus utilizing LED light sources which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED module in accordance with an embodiment of the disclosure.

FIG. 2 is an isometric, inverted view of the LED module of FIG. 1, wherein an LED is removed therefrom.

FIG. 3 is a cross-sectional view of the LED module of FIG. 1, taken along line III-III thereof.

FIG. 4 is a cross-sectional view of the LED module of FIG. 1, taken along line IV-IV thereof.

FIG. 5 shows an equal illumination intensity distribution of the LED module simulated by a computer software.

FIG. 6 shows a plurality of LED modules integrated together.

FIG. 7 shows a street lamp applying the integrated LED modules of FIG. 6.

### DETAILED DESCRIPTION

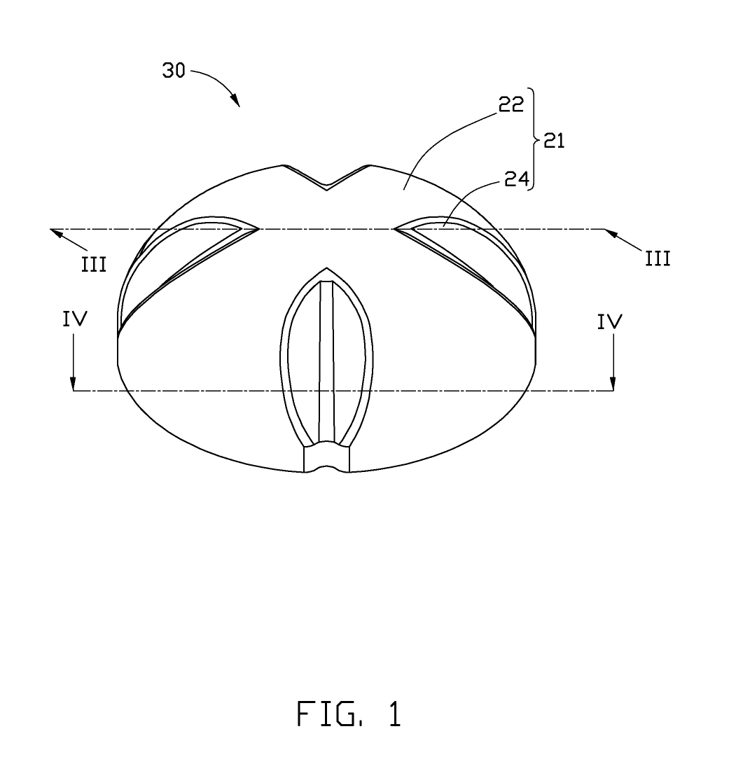

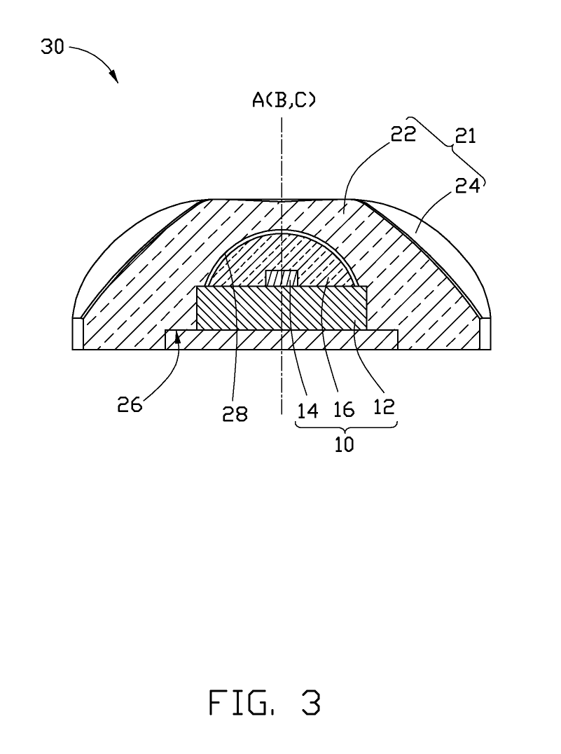

Referring to FIG. 1 and FIG. 3, an LED module 30 in accordance with an embodiment of the disclosure includes an LED 10 and a lens 20 covering the LED 10. The LED 10 includes a base 12, an LED chip 14 mounted on a top face of the base 12 and a transparent encapsulant 16 sealing the LED chip 14 and fixed on the top face of the base 12. The encapsulant 16 is substantially hemispherical. Light emitted from the LED chip 14 passes through the encapsulant 16 when the LED chip 14 is energized. The LED 10 has an optical axis A.

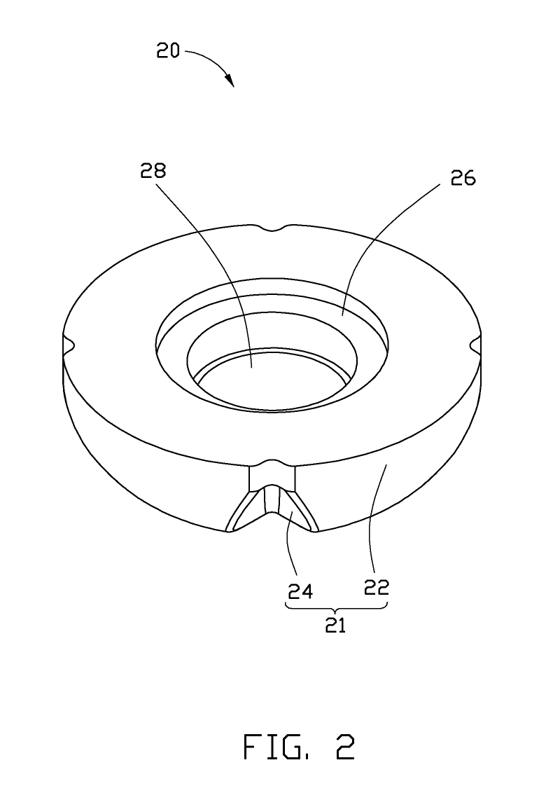

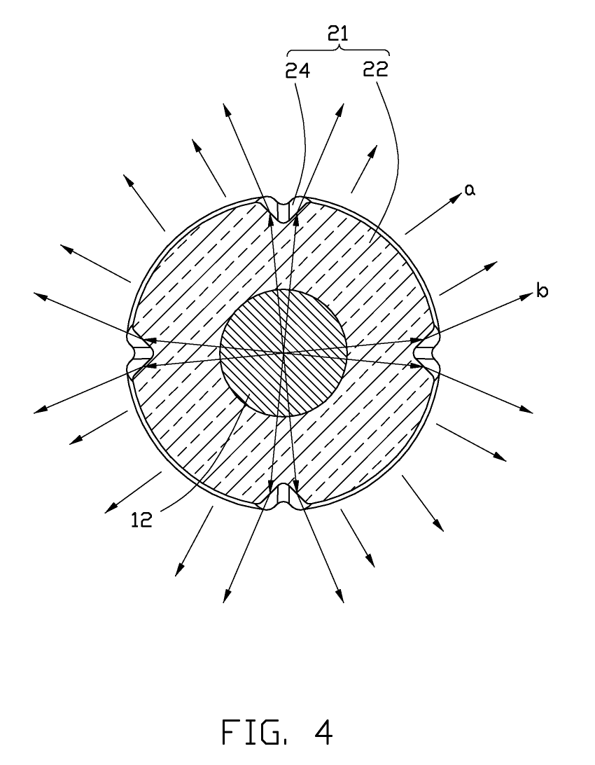

Also referring to FIG. 2 and FIG. 4, the lens 20 is integrally made from a transparent material with good optical property, such as PMMA or PC. The lens 20 has a light input face (not labeled) and a light output face 21. The light output face 21 can refract the light from the light input face and includes a first light output face 22 continuously distributed from a center to a periphery thereof and four second light output faces 24 inwardly recessed relative to the first light output face 22. The light output face 21 has an optical axis B which is coincident with the optical axis A of the LED 10 (shown in FIG. 3). The four second light output faces 24 space from each other with the same interval and are away from the optical axis B of the light output face 21, and are symmetrical about the optical axis B, thereby making the first light output face 22 substantially be a crisscross in shape. Each second light output face 24 is a concaved ellipsoid face; the ellipsoid face can deflect light extending therethrough toward the first light output face 22 adjacent thereto (referring to arrow b shown in FIG. 4), thus making an area on which the entire LED module 30 illuminates be in a crisscross shape. It is noted that the second light output face 24 can be other inwardly-depressed curved face, such as a curved face consisting of two intersecting planes, as long as light extending through the second light output face 24 can be deflected toward the first light output face 22 adjacent thereto.

Particularly referring to FIG. 2 and FIG. 3, the lens 20 inwardly defines a step-shaped groove 26 in a center of a bottom thereof for receiving the base 12 of the LED 10 therein. A hemispherical cavity 28 is further inwardly defined in a center of the groove 26 for receiving the encapsulant 16 of the LED 10 therein. A face of the cavity 28 is a spheric face and acts as the light input face for the light produced by the LED 10 entering into the lens 20. The face of the cavity 28 has an optical axis C which is coincident with the optical axis A and the optical axis B. The face of the cavity 28 can be an aspheric face in an alternative embodiment.

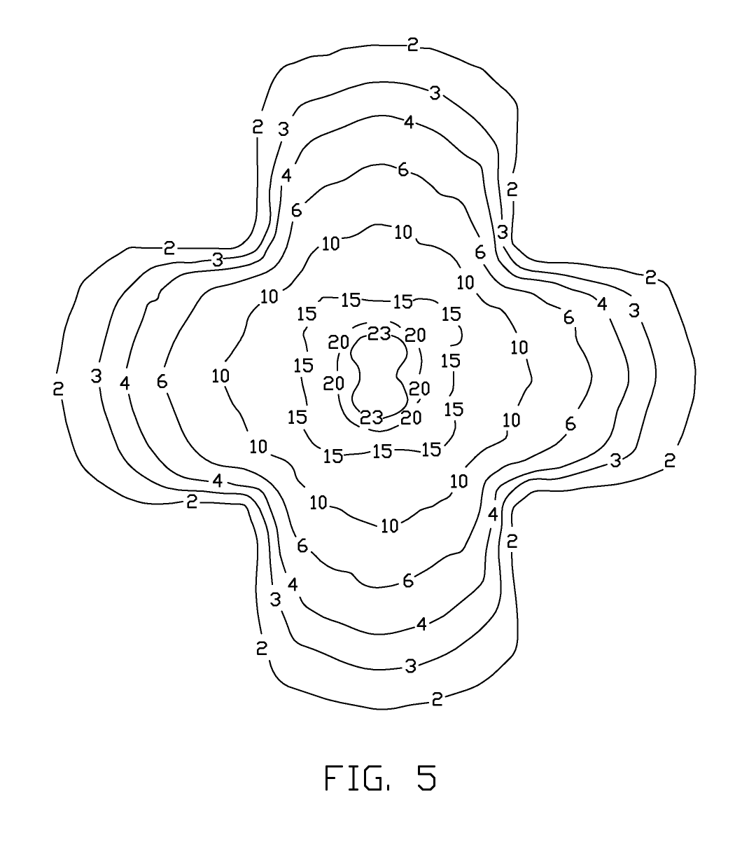

FIG. 5 shows an equal illumination intensity distribution of the LED module 30 simulated by a computer software. An obvious crisscross trace shown in FIG. 5 indicates that the light from the LED module 30 is mostly focused on the crisscross area.

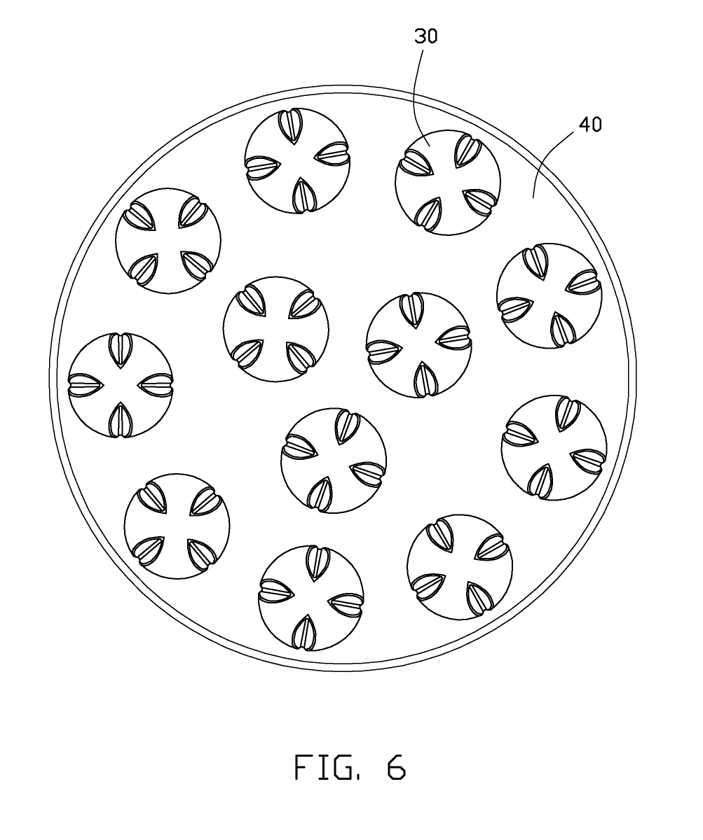

It is noted that a plurality of such LED modules 30 can be integrated on a frame 40 (shown in FIG. 6) to intensify luminous intensity of the light from the LED modules 30.

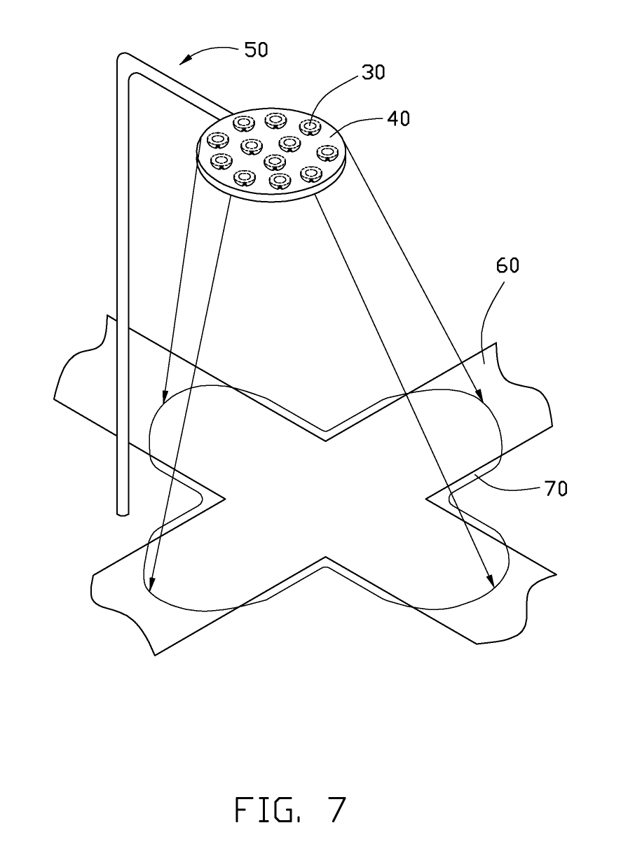

Also referring to FIG. 7, when a street lamp 50 applying the LED modules 30 is mounted by a crossing of two roads 60, the first light output faces 22 of the lenses 20 can converge the light extending therethrough toward the crossing (referring to arrows a shown in FIG. 4). The second light output faces 24 of the lenses 20 can also direct the light extending therethrough toward the crossing (referring to arrows b shown in FIG. 4). Thus, the light from the LED modules 30 is focused over the crossing to form an intersecting illumination area 70, whereby the crossing can be optimally illuminated in a focused manner, without waste of the light generated by the street lamp 50.

In the disclosure, the second light output faces 24 in combination with the first light output face 22 of the lens 20 of the LED module 30 can refract the light from the LED 10 toward the predefined area where illumination is needed, whereby utilization efficiency of the LED light source is thus enhanced effectively.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lens for an LED (light emitting diode), comprising:
a light input face for an incidence of light from an LED chip of the LED into the lens; and
a light output face for refracting the light from the light input face and comprising a first light output face continuously distributed thereon and a plurality of second light output faces inwardly recessed relative to the first light output face;
wherein the second light output faces can deflect the light extending therethrough toward a predefined area where the light extending through the first light output face is focused.

2. The lens as claimed in claim 1, wherein each of the second light output faces is one of an inwardly depressed ellipsoid face and a curved face consisting of two intersecting planes.

3. The lens as claimed in claim 1, wherein the light input face is one of a spherical face and an aspheric face.

4. The lens as claimed in claim 1, wherein the first light output face is a crisscross in shape.

5. The lens as claimed in claim 1, wherein the number of the second light output faces is four so that the light through the lens forms a crisscross illumination shape.

6. An LED module, comprising:
an LED; and
a lens combined with the LED, the lens comprising:
a light input face for light from the LED entering into the lens; and
a light output face for refracting the light from the light input face and comprising a first light output face continuously distributed thereon and a plurality of second light output faces inwardly recessed from the first light output face;
wherein the second light output faces can deflect the light extending therethrough toward a predefined area where the light extending through the first light output face is focused.

7. The LED module as claimed in claim 6, wherein the light passing through the lens forms an intersecting illumination shape.

8. The LED module as claimed in claim 7, wherein the light passing through the lens forms a crisscross illumination shape.

9. The LED module as claimed in claim 6, wherein the LED comprises a base, an LED chip mounted on the base and a transparent encapsulant sealing the LED chip, the light emitted from the LED chip passing through the encapsulant, the lens inwardly defines a step-shaped groove in a bottom thereof, the base of the LED being received in the groove.

10. The LED module as claimed in claim 9, wherein a cavity is further inwardly defined in the groove, the encapsulant of the LED is received in the cavity.

11. The LED module as claimed in claim 10, wherein the face of the cavity acts as the light input face of the lens, and the light input face is one of a spherical face and an aspheric face.

12. The LED module as claimed in claim 6, wherein the light output face has an optical axis which is coincident with that of the light input face.

13. The LED module as claimed in claim 12, wherein the number of the second light output faces is four, the four second light output faces spacing from each other and being symmetrical about the optical axis of the light output face, thereby making the first light output face be a crisscross in shape.

14. The LED module as claimed in claim 6, wherein each of the second light output faces is one of an inwardly depressed ellipsoid face and a curved face consisting of two intersecting planes.

15. An illumination apparatus, comprising:
at least an LED; and
at least a lens combined with the at least an LED, the at least a lens comprising:
a light input face for light from the LED entering into the lens; and
a light output face for refracting the light from the light input face and comprising a first light output face continuously distributed thereon and a plurality of second light output faces inwardly recessed from the first light output face;
wherein the second light output faces can deflect the light extending therethrough toward a predefined area where the light extending through the first light output face is focused.

16. The illumination apparatus as claimed in claim 15, wherein the illumination apparatus is a street lamp mounted by a crossing where roads meet, the at least an LED comprises a number of LEDs, the at least a lens comprises a corresponding number of lens, and the first light output faces of the lenses can converge the light extending therethrough at the crossing, and the second light output faces of the lenses can refract the light extending therethrough toward the crossing.

17. The illumination apparatus as claimed in claim 15, wherein the illumination apparatus is a street lamp mounted by a crossing where roads meet, and the light generated from the at least an LED is focused over the crossing and forms an intersecting illumination shape.
